(19) United States
(12) Patent Application Publication
(10) Pub. No.: US 2013/0036113 A1
(43) Pub. Date: Feb. 7, 2013

(54) System and Method for Automatically Providing a Graphical Layout Based on an Example Graphic Layout

(71) Applicants: Niranjan Damera-Venkata, Mountain View, CA (US); Eamonn O'Brien-Strain, San Francisco, CA (US); Clayton Brian Atkins, Mountain View, CA (US); Nina Bhatti, Los Altos, CA (US)

(72) Inventors: Niranjan Damera-Venkata, Mountain View, CA (US); Eamonn O'Brien-Strain, San Francisco, CA (US); Clayton Brian Atkins, Mountain View, CA (US); Nina Bhatti, Los Altos, CA (US)

(21) Appl. No.: 13/635,408

(22) PCT Filed: Apr. 28, 2010
(86) PCT No.: PCT/US10/32830

§ 371 Date: Sep. 15, 2012

(51) Int. Cl. G06F 17/30

(52) U.S. Cl. 707/724; 707/E17.014

(57) ABSTRACT

Methods and Systems for automatically providing a graphical layout based on an example graphic layout are disclosed. In general, a block boundary analysis is used to identify spatial characteristics of the example graphic layout and an actual content. A database is searched for one or more graphical templates having spatial characteristics that are similar to the spatial characteristics of the example graphic layout. A fit analysis with the spatial characteristics of the actual content is also performed on the graphical templates. The resulting graphical templates are ranked. At least one of the graphical templates in the ranking is automatically filled with the actual content and provided in place of the example graphic layout.

### TECHNICAL FIELD

The present disclosure is related to the field of document generation.

### BACKGROUND

Presently, in order to generate a visually appealing document such as a brochure, pamphlet or the like, a number of actions are involved. For example, a first action is receiving, generating or selecting the data that is to be placed in the document. Another action is selecting or deciding on the size of the document, e.g., single page, single sided, double sided, multiple pages, etc. Another action is designing or choosing a previously designed layout, template for the document,

In a brochure, as one example, there are numerous factors that distinguish a professional looking brochure from an amateur looking brochure. For example, an artist or graphic designer may utilize a number of learned artistic skills in conjunction with innate artistic talent to design a professional looking brochure. In contrast, an amateur may misuse white space, image size, separation, color or other characteristics resulting in a brochure that appears “amateur”.

Deleteriously, the resultant “amateur” brochure may be the result of an amateur's attempt to copy a professional layout. For example, a minor modification to a professional layout can quite easily result in a brochure that appears “amateur”. These slight distinctions are even more apparent when the amateur brochure is compared with one generated by a professional designer.

### SUMMARY

Methods and Systems for automatically providing a graphical layout based on an example graphic layout are disclosed. In general, a block boundary analysis is used to identify spatial characteristics of the example graphic layout and an actual content. A database is searched for one or more graphical templates having spatial characteristics that are similar to the spatial characteristics of the example graphic layout. A fit analysis with the spatial characteristics of the actual content is also performed on the graphical templates. The resulting graphical templates are ranked. At least one of the graphical templates in the ranking is automatically filled with the actual content and provided in place of the example graphic layout.

### BRIEF DESCRIPTION OF THE DRAWINGS

The accompanying drawings, which are incorporated in and form a part of this specification, illustrate examples and, together with the description, serve to explain the principles of the disclosure. Unless specifically noted, the drawings referred to in this description should be understood as not being drawn to scale.

FIG. 1 is a block diagram of a proximity based representation of an example graphic layout and a graphical template.

FIG. 2 is a block diagram of a position based representation of an example graphic layout and a graphical template.

FIG. 3 is a block diagram of an automatic layout producer.

FIG. 4 is a flowchart of a method for creating an automatically filled layout based on an example graphic layout and actual content.

FIG. 5 is a block diagram of an example computer system.

### DETAILED DESCRIPTION

Reference will now be made in detail to examples illustrated in the accompanying drawings. While the present disclosure will be described in conjunction with the following examples, it will be understood that they are not intended to limit the present disclosure to these examples alone. On the contrary, the present disclosure is intended to cover alternatives, modifications, and equivalents which may be included within the spirit and scope of the present disclosure as &:fined by the appended claims. Furthermore, in the following detailed description, numerous specific details are set forth in order to provide a thorough understanding of the present disclosure. However, the systems and methods disclosed herein may be practiced without these specific details. In other instances, known methods, procedures, components, and circuits have not been described in detail so as not to unnecessarily obscure aspects of the present disclosure.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “determining,” “creating,” “differentiating,” “assigning,” “comparing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices,

### Overview

The discussion herein provides methods and systems for producing a “professional” looking layout closely matching a sample (or example graphic) layout provided by the user. In one example, the example graphic layout 101 may he a block sketch, freehand sketch, or the like which is generated by the user. In another example, the sample layout may be a scanned document, brochure, or the like. One example utilizes a block boundary analysis of the example graphic layout 101 to provide search parameters for the sample layout as a graph matching scenario. In so doing, a professional looking layout is generated without requiring additional input from a graphic designer, artist, or the like.

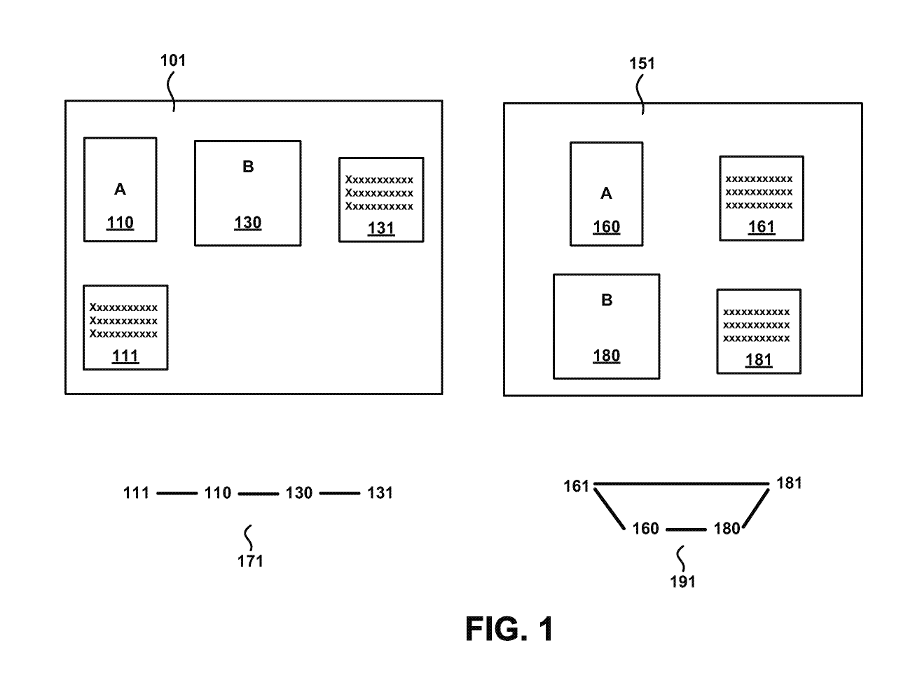

With reference now to FIG. 1, a block diagram of a proximity based representation of an example graphic layout 101 and a graphical template 151 is shown in accordance with one example. Example graphic layout 101 includes an image box 101, image box 130, text block 111 and text block 131. Although two image boxes and two text blocks are shown, the number of each is merely one of a plurality of possible image boxes and text blocks that may be utilized in conjunction with the detailed description provided herewith. The utilization of two image boxes and two text blocks herein are for purposes of clarity. Similarly, graphical template 151 includes an image box 160, image box 180, text block 161 and text block 181.

For purposes of clarity, relating text blocks and image blocks is sometimes referred to as anchoring. It is used to define a relationship between text blocks and image blocks. For example, an image block 110 may have an associated text block 111 that includes text that is directly related to image block 110. Thus, text block 111 would be considered anchored to image block 110.

For purposes of the present discussion, the term example graphic layout 101 and graphical template 151 may refer to a brochure, tri-fold, booklet, pamphlet, leaflet, guide, catalogue, information sheet bulletin, newsletter, handbill, handout, circular and the like. One example graphical template 151 or example graphic layout 101 could be a one-sided, single page brochure for a product that includes at least one image block 110 and at least one text block 111 Another example graphical template 151 or example graphic layout 101 may be a multi-page booklet having a number of images and a number of text blocks. An example of a multi-page booklet may be a car company booklet that provides a number of different car models and associated model data spread across a number of pages.

Yet another example of a graphical template 151 or example graphic layout 101 may he a hi-fold or tri-fold pamphlet that would include at least one image and at least one text block that can he folded for mailings, inserts, etc. An example of a hi-fold or tri-fold pamphlet may be a bank card offer that includes a section that can be removed, filled-out and returned. Another example hi-fold or tri-fold pamphlet may be similar to a health pamphlet found at a medical office, or a takeout menu for a restaurant. Although a number of possible example graphic layouts 101 and graphical templates 151 are described herein, they are not intended to be exhaustive of possible options, descriptions, or the like, ⁻Instead, they are provided as a small sampling to emphasize and clarify the numerous different layout possibilities, sizes and the like which are within the scope of the present technology,

In one example, example graphic layout 101 is a scanned image of a document in a media file type such as Tag(ged) Image File Format (.TIF), Bit Map (.BMP), Graphic Interchange Format (.GIF), Portable Document Format (.PDF), Joint Photographic Experts Group (.JPEG), etc. or an electronic document in a word processing format such as WORD (.DOC), Hypertext Markup Language (HTML); or another suitable document type. In one example, the aspect ratio of the figures is preserved. In another example, text blocks and formatting are preserved. In yet another example, text block formatting and colors etc. may be extracted from the scan, specified by a user or inherited from matched layout templates. However, it is also appreciated that the aspect ratio may be modified. Similarly, in another example, any or all of text block formatting, color, and the like may be modified.

With reference again to FIG. 1, a proximity based graphical representation 171 of example graphic layout 101 is shown. In addition, a proximity based graphical representation 191 of graphical template 151 is also shown. In general, proximity based graphical representations 171 and 191 provide graphical representations of blocks which share a vertical/horizontal boundary edge with one another and are linked by an undirected edge. In one example, isomorphic structures are equivalent or highest scoring while near isomorphic structures arc characterized by a maximum common edge sub-graph. For example, proximity based graphical representation 171 shows that text block 111 has an undirected vertical boundary with image block 110 which has an undirected horizontal boundary with image block 130 which has an undirected horizontal boundary with text block 131.

In contrast, although it is not an exact match, graphical template 151 has a similar proximity based graphical representation 191 to that of example graphic layout 101. For example, proximity based graphical representation 191 shows that text block 161 has an undirected vertical boundary with image block 160 which has an undirected horizontal boundary with image block 180 which has an undirected horizontal boundary with text block 181. However, it should be noted that proximity based graphical representation 191 has an additional undirected horizontal boundary, that is, the boundary between image block 161 and text block 181.

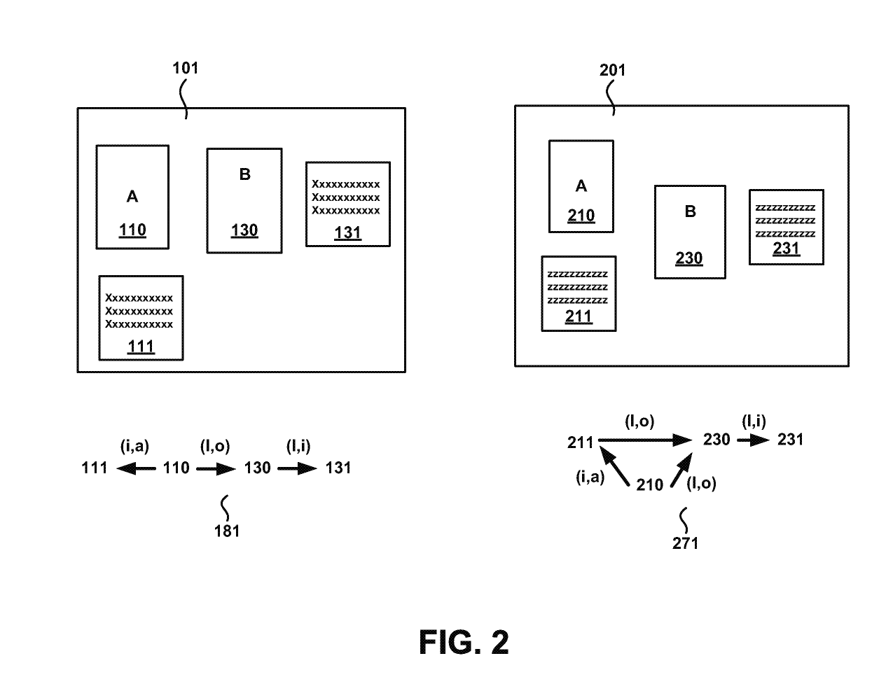

With reference now to FIG. 2, a block diagram of a position based representation of an example graphic layout 101 and a graphical template 201 is illustrated. Example graphic layout 101 includes an image box 101, image box 130, text block 111 and text block 131. Similarly, graphical template 201 includes an image box 210, image box 230, text block 211 and text block 231. Although two image boxes and two text blocks are shown, the number of each is merely one of a plurality of possible image boxes and text blocks that may be utilized in conjunction with the detailed description provided herewith. The utilization of two image boxes and two text blocks herein are for purposes of clarity.

In addition, a position based graphical representation 181 of example graphic layout 101 is shown. Similarly, a position based graphical representation 271 of graphical template 201 is also shown. In one example, position based graphical representations 181 and 271 provide graphical representations of blocks which are linked by an indirect edge with the edge type indicating x and y relative positions. In another example, partial overlap in x or y coordinates can be encoded in edge semantics. For example, position based graphical representation 181 shows that image block 110 includes (i) and is above (a) text block 111. Additionally, position based graphical representation 181 shows that image block 110 is left of (l) and overlaps (o) image block 130. Further, position based graphical representation 181 shows that image block 130 is left of (l) and includes (i) text block 131.

In contrast, although it is not an exact match, graphical template 201 has a similar position based graphical representation 271. For example, position based graphical representation 271 shows that image block 210 includes (i) and is above (a) text block 211. Additionally, position based graphical representation 271 shows that image block 210 is left of (l) and overlaps (o) image block 230. Further, position based graphical representation 271 shows that image block 230 is left of (l) and includes (i) text block 131. However, it should be noted that position based graphical representation 271 has an additional edge relationship, that is, text block 211 is left of (l) and overlaps (o) image block 230.

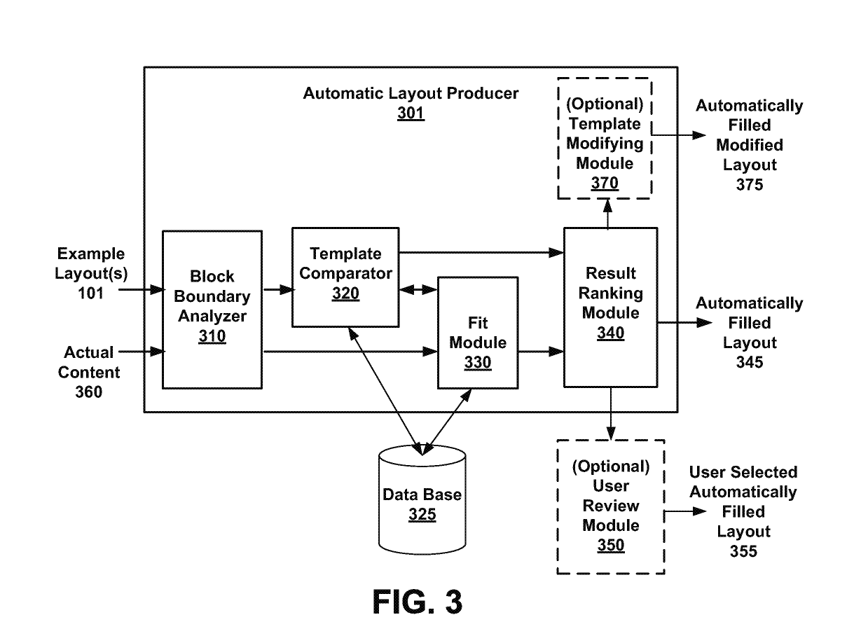

With reference now to FIG. 3, a block diagram of an automatic layout producer 301 is illustrated. In general, automatic layout producer 301 receives at least one example graphic layout 101 in addition to the actual content 360 and provides at least one automatically filled out “professional” looking layout closely matching example graphic layout 101. In one example, automatic layout producer 301 includes a block boundary analyzer 310, template comparator 320, fit module 330 and result ranking module 340. In one example, automatic layout producer 301 can also include an optional user review module 350. Additionally, in one example, automatic layout producer 301 can include an optional template modifying module 370.

Block boundary analyzer 310 generates a graphical interpretation of example graphic layout 101 such as shown in FIGS. 1 and 2. For example, block boundary analyzer 310 automatically analyzes example graphic layout 101 and detect regions in which document layout elements are present. The document layout elements may include text blocks and image blocks. In one example, image blocks refer to images, graphics, photographs, drawings, and other visible components of example graphic layout 101. Alternatively, block boundary analyzer 310 can also allow manual input, such as by using a graphic user interface, to specify various regions occupied by the elements of example graphic layout 101. For purposes of clarity, in the following examples, the description utilizes only two layout elements, text blocks and image blocks.

The graphical interpretation is then provided to template comparator 320. In one example, template comparator 320 searches a database 325 of graphical templates to find graphical templates with graphical interpretations that most closely match the graphical interpretation of example graphic layout 101. Examples of graphical representations of proximity based graphical representation are shown in 171 and 191 of FIG. 1. Examples of graphical representations of position based graphical representation are shown in 181 and 271 of FIG. 2. In another example, template comparator 320 searches the resultant graphical templates from the search of database 325 performed by fit module 330.

In one example, the graphical interpretation of the actual content 360 is provided to fit module 330. In one example, fit module 330 would perform a search of the database 325 for one or more graphical templates 151 that have correlating spatial characteristics.

In another example, fit module 330 receives the graphical templates 151 results from template comparator 320 and then performs a spatial characteristic fit of the provided graphical templates 151 against actual content 360. In other words, graphical templates 151 from template comparator 320 are provided to fit module 330 so they can be evaluated based on how well actual content 360 matches the template.

For example, in one example a probabilistic scoring may be used to maximize a template specific posterior distribution of image scale and whitespace parameters. In one example, once fit module 330 has selected the graphical template 151, graphical template 151 may be automatically presented as automatically filled layout 345. In other words, fit module 330 will automatically incorporate the actual content 360 into the graphical template 151.

In one example, fit module 330 begins at the top of the list of graphical templates received from template comparator 320, however, in another example; fit module 330 may begin at any of the graphical templates. This decision may be based on user input or another metric such as an automatic metric based on the actual content 360. For example, in one example, the actual content 360 may be banking data, but the first template received from template comparator 320 based on the example graphic layout 101 may include an identifier, such as metadata, that describes the template as a birthday invitation. As such, fit module 330 may move directly to the second or other template that has an identifier with a similar field of endeavor as that of the actual content 360.

Template comparator 320 outputs the result of the database 325 graphical template search to ranking module 340. Ranking module 340 then ranks the graphical template results based on spatial relationships such as proximity and position. As further described herein, in another example, the proximity and positional scores can be combined by weighting or candidate high-scoring layouts from each of these methods can be presented via optional user review module 350 for manual selection such as user selected automatically filled layout 355. In another example, optional template modifying module 370 may modify the graphical template 151 to fit the actual data 360 and then automatically provide automatically filled modified layout 375. Additionally, optional template modifying module 370 can modify a number of graphical templates 151 which may then be presented via optional user review module 350 for manual selection of one of automatically filled modified layout 375.

Although a single example graphic layout 101 is described herein, any number of example graphic layouts 101 may be utilized. In one example, each example graphic layout 101 may be individually run through the operations performed by block boundary analyzer 310 and template comparator 320. Then, the graphical template results may be individually ranked by ranking module 340 and then after all example graphic layout(s) 101 have been run though, ranking module 340 will perform an overall ranking of each of the resultant ranking sets.

For example, if two example graphic layouts 101 were utilized, in one example, the resultant top five ranked graphical templates from the first example graphic layout 101 may be templates 25, 156, 754, 35 and 87. Similarly, the resultant top five ranked graphical templates from the second example graphic layout 101 may be templates 48, 87, 67, 380 and 156.

Ranking module 340 would then perform a second ranking between the ten resultant templates. For example, the second ranking may be templates, 156, 87, 25, 48 and 754. However, another example is well suited to weighing or biasing the ranking toward one or more of the example graphic layouts 101. For example, if the ranking were biased toward the second example graphic layout 101 the resultant ranking may be more similar to 87, 156, 48, 67 and 25. Of course, it is understood that the ranking may be biased in numerous different orders. The specific order provided herein is given merely for purposes of clarity.

In another example, instead of each example graphic layout 101 being individually run through the operations performed by block boundary analyzer 310 and template comparator 320, template comparator 320 may instead compare the second (and n) example graphic layout(s) 101 to the results from the most previous example graphic layout 101 search. In other words, after template comparator 320 has performed the first search of database 325, a second search performed by template comparator 320, based on a second example graphic layout 101 may be confined to the graphical templates that were returned as the result of the first search. This process may be similarly repeated for n searches. In one example, after all example graphic layout(s) 101 have been run through template comparator 320, the graphical template results would then be ranked by ranking module 340.

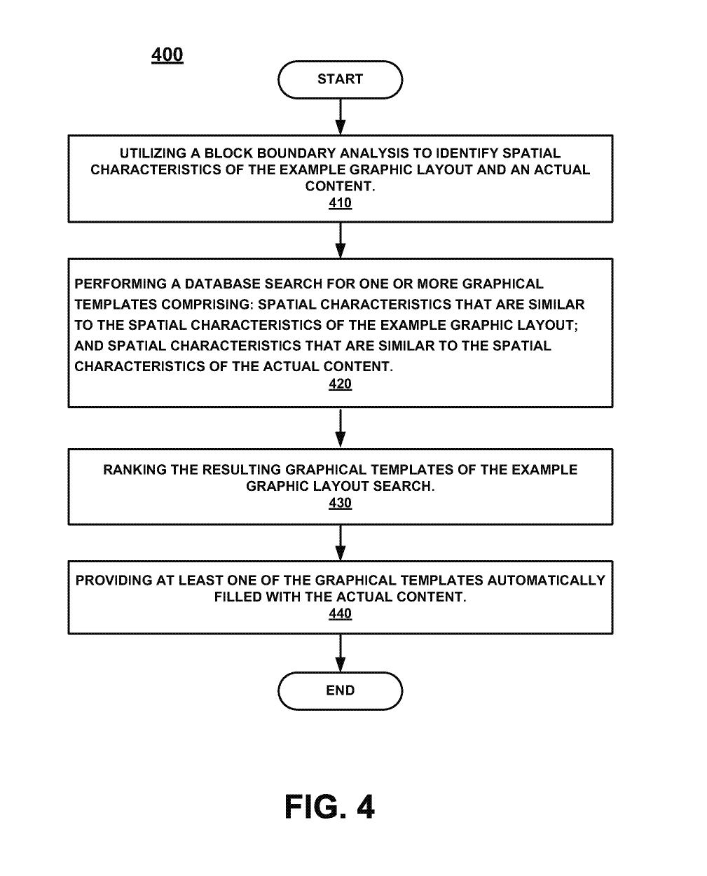

With reference now to FIG. 4, a flowchart 400 of a method for automatically selecting a graphical template based on an example graphic layout is illustrated. For example, the user may not be a graphic designer or wish to hire a graphic designer to provide a proper, balanced, artistically laid out design The technology described herein allows a user to provide layout idea input, referred to herein as example graphic layout 101 in conjunction with actual content 360, and automatically receive a balanced, artistic layout that is similar to their example graphic layout idea.

Referring now to 410 of FIG. 4, one example utilizes a block boundary analysis to identify spatial characteristics of the example graphic layout 101 and an actual content 360. As described herein, example graphic layout 101 is an attempted or desired layout for a brochure, advertisement, tri-fold, or the like.

For example, if the user wanted to make a banking brochure, the user may have picked up one or more brochures that are similar to the type of brochure the user would like to make. The similar brochure would be the example graphic layout 101. Similarly, the user, or another, may have generated a rough sketch that would be the example graphic layout 101.

In addition to the example graphic layout 101, actual data 360 that is to be presented in the final product, e,g., the brochure, tri-fold, advertisement, etc. is also provided. In general, actual content 360 refers to the actual number of images and the actual amount of text that needs to appear in the brochure. For purposes of clarity, the actual data is described in conjunction with images and text blocks. For purposes of the present discussion, images may include a single image, a collage of images or a number of distinct images within a single boundary area. Text blocks may include a single character, a line of text, a list, or the like that may be within a single boundary area.

Some of the images and text blocks in the actual data may standalone. That is, they may have no direct relationship with other images or text blocks. However, other images may have a directly related text blocks. For example, the actual data may include an image of a smiling child that is not related to other text blocks or other images, while another image within the actual data may include a car with a related text block that describes the safety features of the car.

In another example, the actual data may include some images that are directly related to other images. For example, the actual data may include a front view and a side view of the same telephone. Similarly, in another example, the actual data may include some text blocks that are directly related to other text blocks. For example, the actual data may include a text block having a main feature such as “Why move for the future?” and then one or more other text blocks that include subsets of information about the main feature, such as, “security, happiness, independence, etc.”.

In other cases, the actual data may include one image that is directly related to a plurality of text blocks or a plurality of images that are directly related to a single text block. For example, the actual data may include an image of a snowboard and there may be a plurality of text blocks located in proximity around the snowboard image that provide different bits of information directly related to part or all of the snowboard. For example, there may be a text block that discusses the “novel edge design”, another text block that describes the “binding characteristics”, another text block that describes the “graphics”, “technical specifications”, etc.

With reference again to 410 of FIG. 4, in one example, identifying the spatial characteristics is based on a proximity relationship between one or more image blocks and one or more text blocks of the example graphic layout 101. In another example, identifying the spatial characteristics is based on a position relationship between one or more image blocks and one or more text blocks of the example graphic layout 101.

With reference now to 420 of FIG. 4, one example performs a database search for one or more graphical templates having spatial characteristics that are similar to the spatial characteristics of the example graphic layout 101. In one example, the example graphic layout search is performed on all graphic templates in database 325. In another example, the example graphic layout search is performed only on the results of the actual content search.

As stated herein, the search may utilize proximity relationships, position relationships and the like. For example, the proximity based matching allows loose content semantics to be preserved. In so doing, the space of allowed template layouts is expanded without significant risk of breaking semantics. However, positional matching ensures the search is stricter in that it tries to find the best positional matches among all templates that have a given number of figures and a given number of text-blocks. In so doing, returned template layouts more closely follow the example graphic layout 101.

Additionally, in one example, the search may be weighted by user input, automatically based on the actual data type (e.g., automobile data, bank data, flyer data, etc.) and the like. For example, if a search was weighted more heavily on position spatial characteristics, then during the search graphical templates having more similar position spatial characteristics would be selected over graphical template having more similar proximity spatial characteristics. However, in another example, the search may return graphical templates that have similar position and proximity spatial characteristics and then let the result ranking module 340 provide the position or proximity weighting during the ranking process.

With reference still to 420 of FIG. 4 and to FIG. 3, one example performs an actual content 360 comparison search or “fit” for graphical templates with spatial characteristics that are similar to the special characteristics of the actual content. In one example, the actual content 360 search is performed on all graphic templates in database 325. In another example, the actual content 360 search is performed only on the results of the example graphic layout search.

As shown in FIG. 3, in one example, fit module 330 ranks the resulting graphical templates of the actual content comparison search. As stated herein, the ranking may utilize proximity relationships, position relationships or a combination thereof. Additionally, in one example, the ranking may be weighted by user input, automatically based on the actual data type (e.g., automobile data, bank data, flyer data, etc.) and the like. For example, if position spatial characteristics were weighted more heavily than proximity special characteristics, then in one example, graphical templates having more similar position spatial characteristics would be ranked higher than graphical templates having more similar proximity spatial characteristics.

In another example, the actual data ranking of the graphical templates that correlate with the example graphic layout 101 provide a ranking based on “fit”. In other words, the graphical templates that were ranked and returned based on the example graphic layout correlation 440 would be automatically re-ranked based on their fit with the actual data.

In one example, the present technology may break down portions of the example graphic layout 101, any additional example graphic layouts, and actual content 360 to perform a first ranking on an overall graphical template 151 that correlates with example graphic layout 101 to provide a ranking based on “fit” and may then perform a second search and ranking of the graphical templates that correlate with a subsection of example graphic layout 101, any additional example graphic layouts, and the actual data to perform a ranking of a subsection graphic template that correlates with the example graphic layout 101 to provide a ranking based on “fit”. In other words, the graphical templates that were ranked and returned would include an “overall” graphic layout template as well as one or more ranked “subsection” graphical templates. In one example, one or more of the highest ranking “subsection” graphical templates would be automatically placed in the “overall” graphical templates and be automatically provided.

Moreover, in one example, the example graphic layout 101 may be a direct correlation to the number of images and text blocks in the actual data. In other words, the example graphic layout 101 would have the same number of images and text blocks as found in the actual data. However, in another example, the example graphic layout 101 may not be a direct correlation to the images and or text blocks of the actual data. In other words, the example graphic layout 101 would have a different number of images and/or text blocks than the actual data. Moreover, the example graphic layout 101 may not have the exact same image and text blocks relationship as the actual data. For example, the example graphic layout 101 may have a one to one image to text blocks arrangement while the actual data may include an image with two associated text blocks.

In other words, the graphical template may need modification to include the actual data. One example utilizes optional template modifying module 370 to automatically modify the graphical template to include all of the actual data. The resultant automatically filled and modified layout 375 is then provided. The automatically filled and modified template is a usable tangible result that is provided to a GUI, printed, or the like. In another example, one or more of the highest ranking graphical templates are modified in a plurality of possible different layouts and provided to a graphical user interface (GUI) for selection by the user. For example, the plurality of possible different layouts may include a graphical template with a change in the number of pages, a first modified version of a graphical template having a first image-text blocks orientation, another modified version of the same graphical template having a second image-text blocks orientation, etc.

Referring now to 430 of FIG. 4, one example ranks the resulting graphical templates of the example graphic layout search and the actual content search. As stated herein, the ranking may utilize proximity relationships, position relationships or a combination thereof In one example, the ranking may be weighted more heavily for graphical templates that are a better fit with actual content. In another example, the ranking may be weighted more heavily for graphical templates that are a better fit with the example graphic layout.

Additionally, in one example, the ranking may be weighted by user input, automatically based on the actual data type (e.g., automobile data, bank data, flyer data, etc. and the like. For example, if position spatial characteristics were weighted more heavily than proximity special characteristics, then in one example, graphical templates having more similar position spatial characteristics would be ranked higher than graphical templates having more similar proximity spatial characteristics.

In another example, if proximity was the driving aspect of the example graphic layout 101, one example would rank the resultant graphical templates with a higher ranking for templates that had a closer proximity match versus templates having a closer position match. Of course, the weighing of the ranking may be based on any correlation metric, such as position, image number, page number, etc.

In yet another example, the present technology utilizes a second example graphic layout 101 to perform a second ranking of the graphical templates that correlated with the first example graphic layout 101 to provide a second ranking based on aspects of the second example graphic layout 101. In other words, the graphical templates that were ranked and returned based on the first example graphic layout 101 correlations would be automatically re-ranked based on their correlation with the second example graphic layout 101. In one example, one or more of the highest ranking graphical templates are automatically provided.

In one example, it may be faster or more economical to do the actual data spatial characteristics search first, and then rank the results of the actual data spatial characteristics search. Then given the result of the ranking, do another selection process based on example graphic layout characteristics. In another example, it may be faster or more economical to do the example graphic layout search first and then rank the results of the example graphic layout search. Then given the result of the example graphic layout search ranking, do another selection process based on the actual data spatial characteristics.

In yet another example, the actual data spatial characteristics search and the example graphic layout search could be done ‘simultaneously’ and the ranking 430 could take the results of both into account. Additionally, as stated herein, the ranking 430 may also weight the results of one search process higher than the other when performing the ranking.

With reference now to 440 of FIG. 4, one example provides at least one of the graphical templates in the ranking for utilization with the actual content 360 in place of the example graphic layout 101. In one example, one or more of the highest ranking “fit” graphical templates are automatically provided as automatically filled layout 345. In other words, at least one of the graphical templates is automatically filled with the actual data and a completed graphical layout is provided. However, in another example, pluralities of the graphical templates are automatically filled with the actual data and the pluralities of completed graphical layouts are provided for manual selection at user review module 350. In one example, the completed graphic layout(s) are provided to a graphical user interface. However, in another example, the completed graphic layout(s) are printed.

Thus, the systems and methods described herein for automatically selecting a graphical template based on an example graphic layout 101 provide significant advantage when one or more of the proximity, position and fit techniques described herein are utilized. For example, the proximity based matching allows loose content semantics to be preserved. In so doing, the space of allowed template layouts is expanded without significant risk of breaking semantics.

In addition, the positional matching ensures the search is stricter in that it tries to find the best positional matches among all templates that have a given number of figures and a given number of text-blocks, in so doing, returned template layouts more closely follow the users sketch.

Furthermore, the content-fit score can then be utilized to measure how well the user's particular content fits the candidate “close” templates. As such, the combination of one or more of these searching and ranking methodologies provides a powerful technique to leverage a large template collection and produce layouts that have compatible semantics and maintain close spatial relations to the user's example graphic layout.

In other words, the user may not be a graphic designer or wish to hire a graphic designer to provide a proper, balanced, artistically laid out design, however, by utilizing the concepts described herein, a user is able to provide layout idea input, referred to herein as example graphic layout 101 in conjunction with actual content 360, and automatically receive a balanced, artistic layout that is similar to their original layout idea.

### Computer System

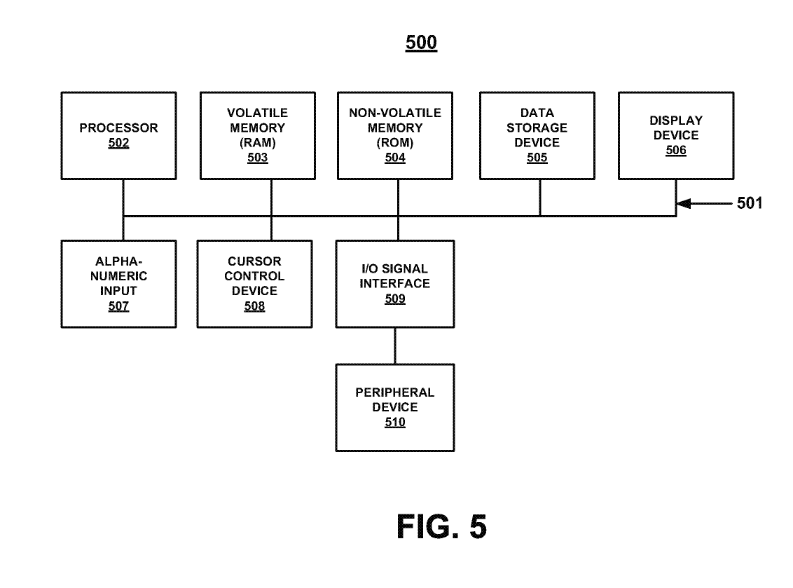

With reference to FIG. 5, certain portions of the system may be comprised of computer-readable and computer-executable instructions that reside, for example, in computer system 500 which is used as a part of a general purpose computer network (not shown). It is appreciated that computer system 500 of FIG. 5 is an example and that the systems can operate within a number of different computer systems including general-purpose computer systems, embedded computer systems, laptop computer systems, hand-held computer systems, and stand-alone computer systems.

In the present example, computer system 500 includes an address/data bus 501 for conveying digital information between the various components, one or more central processor unit(s) (CPU) 502 for processing the digital information and instructions, a volatile main memory 503 comprised of volatile random access memory (RAM) for storing the digital information and instructions, and a non-volatile read only memory (ROM) 504 for storing information and instructions of a more permanent nature. In addition, computer system 500 may also include a data storage device 505 (e.g., a magnetic, optical, floppy, flash, solid state, tape drive or the like) for storing vast amounts of data. It should be noted that the machine readable instructions for creating an editable template from a document image can be stored either in volatile memory 503, data storage device 505, or in an external storage device (not shown).

Devices which can be coupled to computer system 500 include a display device 506 for displaying information to a computer user, an alpha-numeric input device 507 (e.g., a keyboard), and a cursor control device 508 (e.g., mouse, trackball, light pen, etc.) for inputting data, selections, updates, etc. Computer system 500 can also include a mechanism for emitting an audible signal (not shown). In addition, the display device 506 and alpha-numeric input device 507 may be combined such as a touch screen, capacitive sensor, or other type of interactive display capable of receiving user input.

Returning still to FIG. 5, optional display device 506 of FIG. 5 may be a liquid crystal device, cathode ray tube, or other display device suitable for creating graphic images and alpha-numeric characters recognizable to a user. A cursor control device 508 allows the computer user to dynamically signal the two dimensional movement of a visible symbol (cursor) on a display screen of display device 506. Many implementations of cursor control device 508 are known in the art including a trackball, mouse, touch pad, joystick, or special keys on alpha-numeric input 507 capable of signaling movement of a given direction or manner displacement. Alternatively, it will be appreciated that a cursor can be directed and/or activated via input from alpha-numeric input 507 using special keys and key sequence commands. Alternatively, the cursor may be directed and/or activated via input from a number of specially adapted cursor directing devices.

Furthermore, computer system 500 can include an input/output (I/O) signal unit (e.g., interface) 509 for interfacing with a peripheral device 510 (e.g., a computer network, modem, mass storage device, etc.). Accordingly, computer system 500 may be coupled in a network, such as a client/server environment, whereby a number of clients (e.g., personal computers, workstations, portable computers, minicomputers, terminals, etc.) are used to run processes for performing desired tasks. In particular, computer system 500 can be coupled in a system for creating an editable template from a document.

While the present invention has been described in particular embodiments, it should be appreciated that the present invention should not be construed as limited by such embodiments, hut rather construed according to the following claims.

What is claimed is:

1. A method for automatically providing a graphical layout 345 based on an example graphic layout 101, said method comprising:
utilizing a block boundary analysis 410 to identify spatial characteristics of the example graphic layout 101 and an actual content 360;
performing a database 325 search 420 for one or more graphical templates 151 comprising:
spatial characteristics that are similar to the spatial characteristics of the example graphic layout 101; and
spatial characteristics that are similar to the spatial characteristics of the actual content 360;
ranking 430 the resulting graphical templates 151 of said database 325 search; and
providing 450 at least one of the graphical templates 151 in said ranking automatically filled with the actual content 360 in place of said example graphic layout 101.

2. The method as recited in claim 1 further comprising:
receiving at least one additional example graphic layout 101;
performing a block boundary analysis to identify spatial characteristics of the at least one additional example graphic layout 101;
performing an additional example graphic layout search on the results of said example graphic layout search for one or more graphical templates 151 having spatial characteristics that are similar to the spatial characteristics of the at least one additional example graphic layout 101;
ranking the results of said additional example graphic layout search; and
providing at least one of the graphical templates 151 in said ranking for utilization with said actual content 360 in place of said example graphic layout 101.

3. The method as recited in claim 1 further comprising:
identifying the spatial characteristics based on a proximity relationship between one or more image blocks and one or more text blocks of said example graphic layout 101.

4. The method as recited in claim 1 further comprising:
identifying the spatial characteristics based on a position relationship between one or more image blocks and one or more text blocks of said example graphic layout 101.

5. The method as recited in claim 1 further comprising:
breaking down the example graphic layout 101 into an overall graphic layout template and one or more subsection graphic layouts.

6. The method as recited in claim 5 further comprising:
performing a first database 325 search for one or more graphical templates 151 having spatial characteristics that are similar to the spatial characteristics of the example graphic overall graphic layout; and
performing one or more additional database 325 searches for one or more graphical templates 151 having spatial characteristics that are similar to the spatial characteristics of the one or more subsection graphic layouts.

7. The method as recited in claim 6 further comprising:
performing a first ranking for one or more graphical templates 151 having spatial characteristics that are similar to the spatial characteristics of the overall graphic layout; and
performing one or more additional rankings for one or more resulting graphical templates 151 having spatial characteristics that are similar to the spatial characteristics of the one or more subsection graphic layouts.

8. The method as recited in claim 7 further comprising:
performing a fit analysis with the spatial characteristics of the actual content 360 for the overall graphic layout and for the one or more subsection graphic layouts;
utilizing a result of said fit analysis to combine said overall graphic layout and the one or more subsection graphic layouts into at least one single graphic layout;
automatically filling said at least one single graphic layout with the actual content 360; and
outputting said at least one single graphic layout with the actual content 360 in place of said example graphic layout 101.

9. The method as recited in claim 1 wherein providing at least one of the templates comprises:
providing a plurality of said graphical templates 151 automatically filled with the actual content 360 for utilization in place of said example graphic layout 101 based on the ranking to a graphical user interface for manual selection.

10. An automatically graphical layout provider comprising:
a block boundary analyzer 310 to identify spatial characteristics of the example graphic layout 101 and an actual content 360;
a template comparator 320 that utilizes the spatial characteristics of the example graphic layout 101 from the block boundary analyzer 310 to search a database 325 for one or more graphical templates 151 having similar spatial characteristics;
a fit module 330 that utilizes the spatial characteristics of the actual content 360 to search a database 325 for one or more graphical templates 151 having similar spatial characteristics; and
a result ranking module 340 to rank the graphic template results from said template comparator search and said fit module search to provide at least one of the graphical templates 151 automatically filled with the actual content 360.

11. The automatically graphical layout provider of claim 10 further comprising:
a user review module 350 to provide a plurality of graphical templates 151 automatically filled with the actual content 360 for manual selection.

12. The automatically graphical layout provider of claim 10 wherein said fit module 330 automatically provides a graphical template automatically filled with the actual content 360.

13. The automatically graphical layout provider of claim 10 wherein a plurality of example graphic layouts are utilized.

14. The automatically graphical layout provider of claim 10 wherein the block boundary analyzer 310 identifies the spatial characteristics based on a proximity relationship between one or more image blocks and one or more text blocks of said example graphic layout 101.

15. The automatically graphical layout provider of claim 10 wherein the block boundary analyzer 310 identifies the spatial characteristics based on a position relationship between one or more image blocks and one or more text blocks of said example graphic layout 101.
